(19) United States
(12) Patent Application Publication
(10) Pub. No.: US 2020/0180792 A1
(43) Pub. Date: Jun. 11, 2020

(54) FATIGUE LEVEL CALCULATING DEVICE, FATIGUE LEVEL CALCULATING METHOD, ACTUATOR, ACTUATOR CONTROLLING DEVICE, AND AIRCRAFT

(71) Applicant: NABTESCO CORPORATION, Tokyo (JP)

(72) Inventors: Yoshiaki OKUNO, Tokyo (JP); Koji ITO, Tokyo (JP); Hiroaki HONDA, Tokyo (JP); Ryosuke GOTANDA, Tokyo (JP)

(21) Appl. No.: 16/704,260

(22) Filed: Dec. 5, 2019

(30) Foreign Application Priority Data
Dec. 5, 2018 (JP) 2018-228263

(51) Int. Cl. B64F 5/60; B64F 5/40; G07C 5/08; G06N 20/00

(52) U.S. Cl. CPC B64F 5/60; B64F 5/40; B64D 2045/0085; G06N 20/00; G07C 5/0808

(57) ABSTRACT

A fatigue level calculating device includes an environment information acquiring unit that acquires environment information pertaining to an environment in the surroundings of equipment, and a fatigue level calculating unit that calculates a relationship between an operation condition of the equipment and a fatigue level of the equipment based on the environment information.

### CROSS REFERENCE TO RELATED APPLICATION

The present application claims priority under 35 USC 119 to Japanese Application No. 2018-228263 filed on Dec. 5, 2018, the entire disclosures of which are incorporated herein reference.

### BACKGROUND OF THE INVENTION

### 1. Field of the Invention

The present invention relates to a fatigue level calculating device, a fatigue level calculating method, an actuator, an actuator controlling device, and an aircraft.

### 2. Description of the Related Art

Transportation equipment, such as an aircraft, needs to have its body and components maintained at an appropriate timing for the safety of service. Patent document 1 describes a maintenance system that collects sensing data pertaining to the condition of a component of a machine while the machine is in operation and transmits anomaly detection information to a network based on an anomaly score calculated from the sensing data.

[patent document 1] JP2017-142654

Currently, at many sites, equipment is maintained through regular inspections. However, the fatigue level of equipment normally varies depending on the operation patterns, such as an outer environment during operation. In that case, maintaining every piece of equipment uniformly through regular inspections poses a problems in that some pieces of equipment malfunction due to delayed maintenance or the cost increases due to unnecessary early maintenance.

According to the technique described in patent document 1, the sensing data pertaining to the condition of a component collected during operation is analyzed in real time, and an anomaly is detected when the sensing data exceeds a predetermined threshold. In other words, this technique collects, as the sensing data, the condition of a component in the equipment that has deteriorated to a certain extent, and an anomaly is detected based on that extent. However, this technique fails to predict the progress of future deterioration based on an operation pattern or the like before the equipment actually starts deteriorating.

### SUMMARY OF THE INVENTION

The present invention has been made in view of the foregoing and is directed to predicting the fatigue level of equipment based on an operation pattern of the equipment.

To solve the above-described issue, a fatigue level calculating device according to an aspect of the present invention includes an environment information acquiring unit that acquires environment information pertaining to an environment in surroundings of equipment, and a fatigue level calculating unit that calculates a relationship between an operation condition of the equipment and a fatigue level of the equipment based on the environment information.

Another aspect of the present invention provides a fatigue level calculating method. The method includes an environment information acquiring step of acquiring environment information pertaining to an environment in surroundings of equipment, and a fatigue level calculating step of calculating a relationship between an operation condition of the equipment and a fatigue level of the equipment based on the environment information.

Yet another aspect of the present invention provides an actuator. The actuator includes an output unit that outputs a power, an environment information acquiring unit that acquires environment information pertaining to an environment in surroundings of the output unit, and a fatigue level calculating unit that calculates a relationship between an operation condition of the output unit and a fatigue level of the output unit based on the environment information acquired by the environment information acquiring unit.

Yet another aspect of the present invention provides an actuator controlling device. The actuator controlling device includes a control unit that controls an output unit that outputs a power, an environment information acquiring unit that acquires environment information pertaining to an environment in surroundings of the control unit, and a fatigue level calculating unit that calculates a relationship between an operation condition of the control unit and a fatigue level of the control unit based on the environment information acquired by the environment information acquiring unit.

Yet another aspect of the present invention provides an aircraft. The aircraft includes an aircraft body capable of flying and including a plurality of devices, and a fatigue level calculating device that includes an environment information acquiring unit that acquires environment information pertaining to an environment in surroundings of at least one of the plurality of devices or the aircraft body and a fatigue level calculating unit that calculates a relationship between an operation condition of the at least one of the plurality of devices or the aircraft body and a fatigue level of the at least one of the plurality of devices or the aircraft body based on the environment information.

It is to be noted that any optional combination of the above constituent elements or an embodiment obtained by mutually substituting the constituent elements of the present invention or what is expressed by the present invention among a method, a device, a program, a transitory or non-transitory storage medium having a program recorded therein, a system, and so on is also effective as an aspect of the present invention.

### BRIEF DESCRIPTION OF THE DRAWINGS

FIG. 1 is a graph illustrating a relationship between the number of flights of a plurality of aircraft bodies operated in different operation patterns and the frequency of failures in actuators of the aircraft bodies;

FIG. 2 is a graph illustrating a relationship between the number of flights of the plurality of aircraft bodies operated in the operation patterns illustrated in FIG. 1 and the fatigue score of the actuators of the aircraft bodies;

FIG. 3 is a functional block diagram illustrating a configuration of a fatigue level calculating device according to a first embodiment;

FIG. 4 is a schematic diagram illustrating an environment information acquiring unit and its peripheral equipment of a fatigue level calculating device according to a second embodiment;

FIG. 5 is a flowchart of a fatigue level calculating method according to a third embodiment;

FIG. 6 is a flowchart of a fatigue level calculating method according to a fourth embodiment;

FIG. 7 is a flowchart of a fatigue level calculating method according to a fifth embodiment;

FIGS. 8A-FIG. 8C illustrate an operation management of an aircraft body according to the embodiment illustrated in FIG. 7; and

FIGS. 9A-FIG. 9C is a graph illustrating accumulation of fatigue scores of each aircraft body obtained when the operation management illustrated in FIGS. 8A-FIG. 8C has been performed.

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the drawings. Identical or equivalent constituent elements, members, and processes illustrated in the drawings are given identical reference characters, and duplicate descriptions thereof will be omitted as appropriate.

Prior to describing specific embodiments, underlying knowledge forming the basis will be described first.

Fatigue of equipment progresses as a load exerted on the equipment during operation accumulates. The fatigue level of such equipment varies depending on the operation patterns, such as an outer environment during operation. In the following, with an actuator used in flight control of an aircraft serving as an example, a relationship between an operation pattern (e.g., outer environment) and an operation condition (e.g., the number of flights or the flight frequency) will be described.

In the present specification, the term “during operation” refers to a duration or a state in which a function of equipment is in a state of being available for use. For example, in the case of an aircraft, the term “during operation” refers to a duration or a state in which the aircraft is in the air or is moving on a runway (including moving while being towed). The term “before operation” refers to a duration or a state in which equipment is temporarily being stored and refers to a state in which the equipment has not entered the state of being “during operation.” For example, in the case of an aircraft, the term “before operation” refers to a duration or a state in which the aircraft is being parked to board passengers at an airport. The term “after operation” refers to a duration or a state in which equipment is temporarily being stored and refers to a state that comes after the equipment has been in the state of being “during operation.” For example, in the case of an aircraft, the term “after operation” refers to a duration or a state in which the aircraft is being parked to drop off passengers at an airport. A duration or a state in which crew members, including a pilot, are getting off an aircraft may be included in the term “after operation.”

Intrusion of the moisture that is produced due to the difference between the temperature on the ground and the temperature in the sky results in a load and causes fatigue in an actuator. The fatigue progresses along with an increase in the number of flights and eventually leads to faulty insulation resistance in the actuator. Thus, the faulty insulation resistance in the actuator occurs earlier as the outside humidity is higher and as the difference between the temperature on the ground and the temperature in the sky is greater. The term “fatigue” as used herein means a factor or a state that prevents equipment from exhibiting its expected performance.

For example, the difference between the temperature on the ground and the temperature in the sky is greater in a tropical region than in a cold region. Therefore, when an aircraft body operated in a tropical region is compared with an aircraft body operated in a cold region, even if the number of flights is the same, the fatigue level, that is, the magnitude of the accumulated fatigue is greater in the former than in the latter. When this fatigue level exceeds a predetermined threshold, the equipment falls into a state in which the equipment is seriously prevented from exhibiting its expected performance, leading to an increased probability of failure. In this manner, the relationship between the operation condition (the number of flights) and the risk of failure varies depending on the operation pattern (the outer environment, such as the temperature).

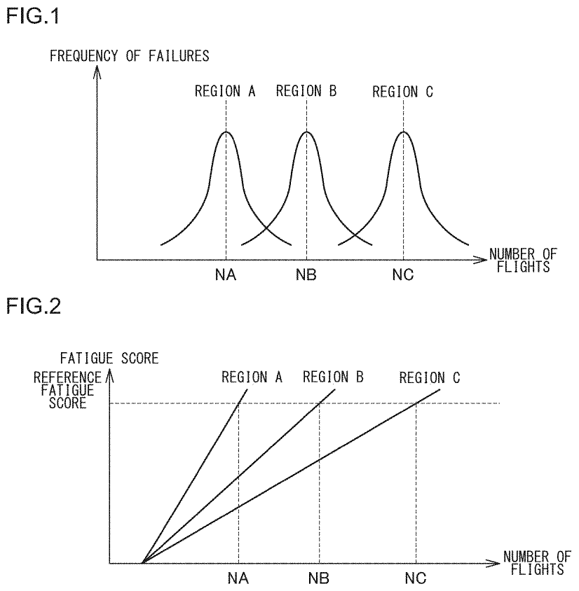

FIG. 1 is a graph illustrating a relationship between the number of flights of a plurality of aircraft bodies operated in different regions A, B, and C and the frequency of failures in the actuators of these aircraft bodies. Herein, the region A is a tropical region, the region B is a mild climate region, and the region C is a cold region, for example. Thus, the load exerted on the actuators, that is, the fatigue level descends in order of the regions A, B, and C. NA, NB, and NC represent the numbers of flights at which the frequency of failures is highest in the respective regions. As illustrated in FIG. 1, the greater the load exerted on the actuator, the earlier a failure occurs.

The relationship between the number of flights and the fatigue level of the actuators corresponding to the respective operated regions can be calculated by analyzing the number of flights of the plurality of aircraft bodies operated in the respective regions A, B, and C and data on the frequency of failures.

FIG. 2 is a graph illustrating a relationship between the number of flight of the aircraft bodies operated in the respective regions A, B, and C and the “fatigue score” of the actuators calculated as described above. Herein, the fatigue score is the fatigue level expressed in a numerical value of a predetermined format.

The fatigue scores held when the numbers of flights in the respective regions are NA, NB, and NC indicated in FIG. 1 are each referred to as a “reference fatigue score.” The reference fatigue score is regarded as a type of threshold indicating the fatigue level at which the probability of failure in an actuator exceeds a predetermined reference if the fatigue progresses any further.

The graph illustrated in FIG. 2 is calculated by statistically fitting the fatigue score onto a straight line under the assumption that the fatigue score is a linear function of the number of flights. However, the relationship between the number of flights and the fatigue score is not limited to a linear function, and any preferred functional shape that is expressed by a polygon graph or another curved line graph may also be assumed. Alternatively, no specific functional shape needs to be assumed in advance for the relationship between the number of flights and the fatigue score, and the relationship may be calculated while generating a functional shape serving as a model through machine learning, artificial intelligent, or the like. Alternatively, the relationship between the number of flights and the fatigue score may be calculated in the form of a lookup table instead of a function expressed by a graph.

As described above, a technical feature of the present invention lies in that the relationship between the operation condition of equipment and the fatigue level of the equipment is predicted based on the operation pattern of the equipment that could cause fatigue or deterioration, instead of predicting a failure from an anomaly or the like of sensing data observed as a result of the progress in the deterioration of the equipment.

In each of the following embodiments, equipment of which the fatigue level is to be calculated may be any equipment and, in particular, may be transportation equipment, such as an aircraft, or a device constituting a portion of transportation equipment.

### First Embodiment

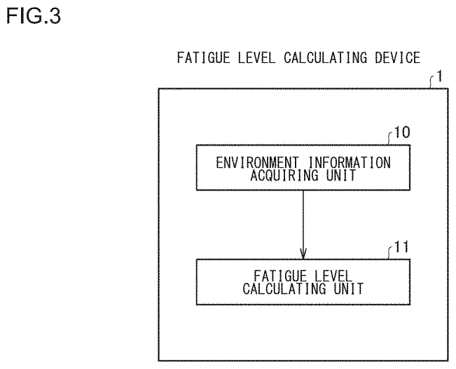

FIG. 3 is a functional block diagram illustrating a configuration of a fatigue level calculating device 1 according to a first embodiment. The fatigue level calculating device 1 includes an environment information acquiring unit 10 and a fatigue level calculating unit 11.

The environment information acquiring unit 10 acquires environment information pertaining to an environment in the surroundings of equipment. The environment information may indicate, for example, weather information such as the temperature or the humidity, the amount of dust, a surge voltage caused by lightning or the like, the concentration of a chemical substance such as a photochemical oxidant, the radiation exposure dose of cosmic rays or the like. Herein, the term “surroundings” refers to a range in which environment information substantially identical to the environment information to be obtained at a position where equipment is disposed can be acquired. This is a concept that includes, aside from the vicinity of the position where the equipment is disposed, the space where the equipment is disposed or another space that is connected to the space where the equipment is disposed. The term “substantially identical” refers to a range in which substantially the same result can be obtained in calculating the fatigue level.

The environment information acquiring unit 10 can acquire the environment information through a well-known method suitable for the environment information.

For example, the environment information acquiring unit 10 may acquire the environment information during operation of the equipment. In this case, the environment information acquiring unit 10 may acquire the environment information with the use of a sensor provided in the surroundings of the equipment.

Alternatively, the environment information acquiring unit 10 may acquire the environment information before operation of the equipment. In this case, the environment information acquiring unit 10 may acquire the environment information as an operator inputs the environment information based on a service record or a failure record. Alternatively, a database in which the environment information is accumulated each time the equipment is operated may be constructed, and data may be uploaded to the environment information acquiring unit 10 from this database at a prescribed timing. Furthermore, with regard to the environment information, such as the temperature or the humidity, published by the Meteorological Agency or the like, the published information may be used.

Alternatively, the environment information acquiring unit 10 may acquire the environment information after operation of the equipment. For example, the environment information acquiring unit 10 may acquire detailed environment information recorded during a service on the day following the service. Such actually recorded environment information is accurate and is thus useful for achieving accurate service management or the like based on the fatigue level.

The fatigue level calculating unit 11 calculates the relationship between the operation condition of the equipment and the fatigue level of the equipment based on the environment information acquired by the environment information acquiring unit 10.

The fatigue level calculating unit 11 may calculate the relationship between the operation condition of the equipment and the fatigue level of the equipment through any desired method.

The relationship may be calculated through fitting onto a predetermined function based on a statistical technique, such as a multiple regression analysis, for example. Alternatively, the relationship may be calculated through machine learning, deep learning, or artificial intelligence.

According to the present embodiment, the relationship between the operation condition of the equipment and the fatigue level of the equipment can be predicted based on the operation pattern of the equipment that could cause fatigue or deterioration.

### Second Embodiment

An overall configuration of a fatigue level calculating device 1 according to a second embodiment is the same as the overall configuration of the fatigue level calculating device 1 illustrated in FIG. 3. In particular, in the second embodiment, an environment information acquiring unit includes a temperature sensor and a humidity sensor attached to a manifold of an actuator in an aircraft.

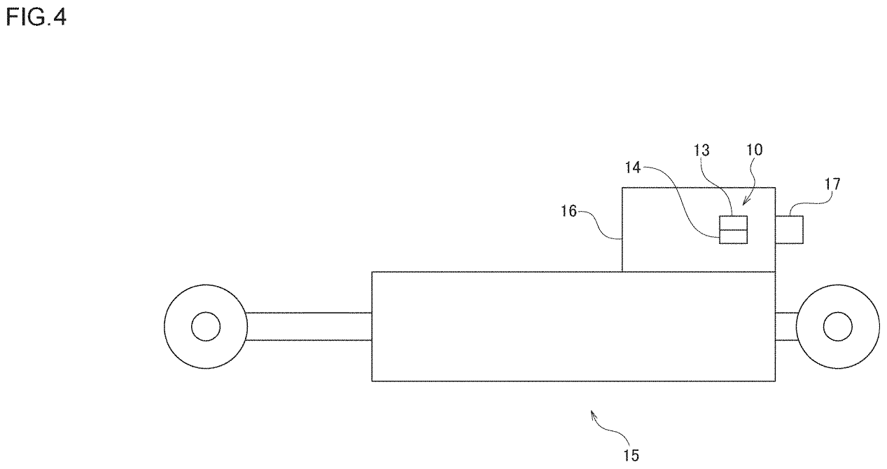

FIG. 4 is a schematic diagram illustrating an environment information acquiring unit 10, an actuator 15, a manifold 16, and an electrical connector 17 of the fatigue level calculating device according to the second embodiment. The environment information acquiring unit 10 includes a temperature sensor 13 and a humidity sensor 14. The temperature sensor 13 senses and acquires the temperature in the surroundings of the manifold 16, and the humidity sensor 14 senses and acquires the humidity in the surroundings of the manifold 16.

An electrical component, such as a sensor (not illustrated) called LVDT or a valve (not illustrated) called EHSV, is embedded in the manifold 16. The electrical connector 17 in which wires of such an electrical component gather is likely to become a path through which the moisture intrudes. As described above, the moisture is produced largely due to the difference between the temperature on the ground and the temperature in the sky. The humidity is information directly related to the moisture. Therefore, in order to predict a failure that occurs due to an electrical deterioration, such as faulty insulation resistance, caused by intruding moisture, it is desirable that the accurate temperature and humidity in the surroundings of the electrical connector 17 can be acquired.

The environment information acquiring unit is not limited to a temperature sensor or a humidity sensor and may be any suitable sensor provided in the surroundings of the equipment.

In addition, the environment information acquiring unit is not limited to a sensor and may be any suitable device exposed to the environment in the surroundings of the equipment.

According to the present embodiment, the accurate temperature and humidity in the surroundings of an electrical connector can be acquired.

### Third Embodiment

FIG. 5 is a flowchart of a fatigue level calculating method according to a third embodiment. This method includes an environment information acquiring step S1 and a fatigue level calculating step S2.

In the environment information acquiring step S1, the method acquires the environment information pertaining to the environment in the surroundings of the equipment. The environment information may be, for example, the temperature, the humidity, the amount of dust, the surge voltage, the concentration of a chemical substance, the radiation exposure dose, or the like.

In the environment information acquiring step S1, the method can acquire the environment information through any desired method.

For example, in the environment information acquiring step S1, the method may acquire the environment information during operation of the equipment. In this case, in the environment information acquiring step S1, the method may acquire the environment information with the use of a sensor provided in the surroundings of the equipment.

In the environment information acquiring step S1, the method may acquire the environment information before operation of the equipment. In this case, in the environment information acquiring step S1, the method may acquire the environment information as an operator inputs the environment information based on a service record or a failure record. Alternatively, a database in which the environment information is accumulated each time the equipment is operated may be constructed, and data may be uploaded from this database at a prescribed timing in the environment information acquiring step S1.

In the fatigue level calculating step S2, the method calculates the relationship between the operation condition of the equipment and the fatigue level of the equipment based on the environment information acquired in the environment information acquiring step S1.

In the fatigue level calculating step S2, the method may calculate the relationship between the operation condition of the equipment and the fatigue level of the equipment through any desired method.

The relationship may be calculated through fitting onto a predetermined function based on a statistical technique, such as a multiple regression analysis, for example. Alternatively, the relationship may be calculated based on machine learning, deep learning, or artificial intelligence.

According to the present embodiment, the relationship between the operation condition of the equipment and the fatigue level of the equipment can be predicted based on the operation pattern of the equipment that could cause fatigue or deterioration.

### Fourth Embodiment

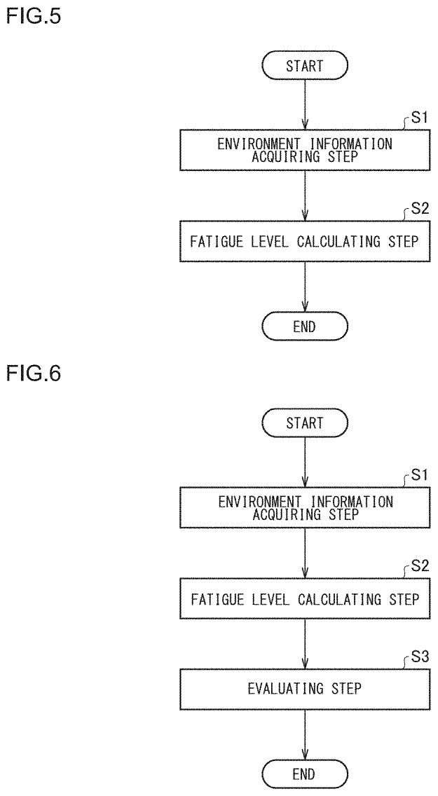

FIG. 6 is a flowchart of a fatigue level calculating method according to a fourth embodiment. The fatigue level calculating method illustrated in FIG. 6 includes an evaluating step S3, in addition to the steps in the fatigue level calculating method illustrated in FIG. 5.

In the evaluating step S3, the method compares the fatigue level calculated from the relationship calculated in the fatigue level calculating step S2 against a predetermined threshold for an evaluation.

For example, the reference fatigue score illustrated in FIG. 2 may serve as the threshold, and thus the fatigue level at which the probability of failure in an actuator increases can be evaluated. The threshold is not limited to the reference fatigue score itself and may be a value obtained by multiplying the reference fatigue score by a predetermined value or a value obtained by adding or subtracting a predetermined value to or from the reference fatigue score. The evaluation result obtained in the evaluating step S3 can be used, for example, to determine the timing of maintenance on the equipment. For example, the maintenance timing can be set to the timing at which the fatigue level matches the threshold or to the timing at which the difference between the fatigue level and the threshold is smaller than a predetermined value. Thus, an appropriate maintenance timing can be set for each piece of equipment used in a different operation pattern.

According to the present embodiment, the fatigue level of the equipment at which the probability of failure increases can be evaluated based on the operation pattern of the equipment.

### Fifth Embodiment

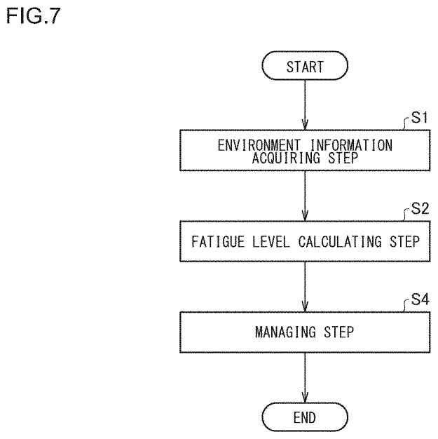

FIG. 7 is a flowchart of a fatigue level calculating method according to a fifth embodiment. The fatigue level calculating method illustrated in FIG. 7 includes a managing step S4, in addition to the steps in the fatigue level calculating method illustrated in FIG. 5.

In the managing step S4, the method manages the operation of the equipment based on the fatigue level calculated from the relationship calculated in the fatigue level calculating step S2.

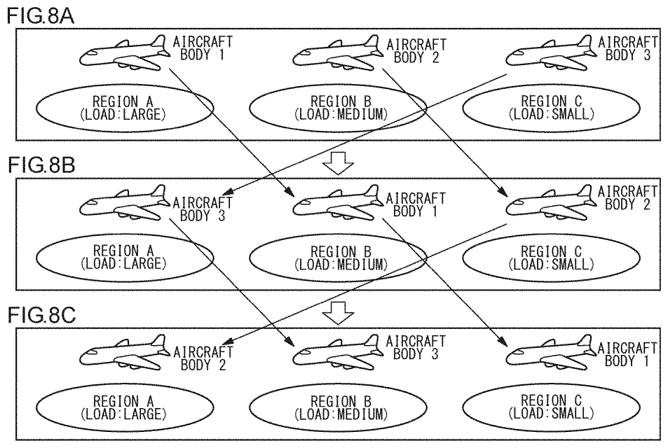

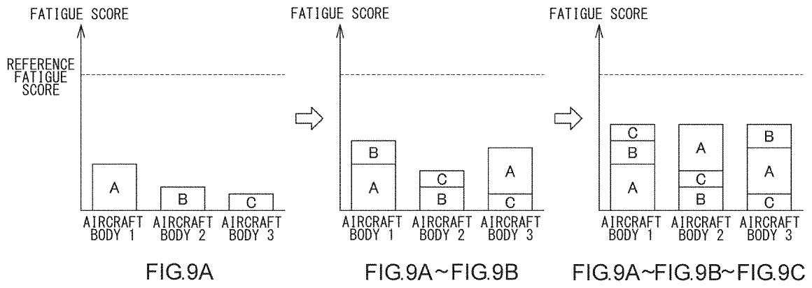

In the operation management of the equipment, the operation pattern of each piece of equipment may be swapped so that the fatigue level of a plurality of pieces of equipment becomes even. An example of such operation management will be described with reference to FIGS. 8A-FIG. 8C and FIGS. 9A-FIG. 9C.

FIGS. 8A-FIG. 8C illustrate the operation management of an aircraft body in the managing step S4.

FIGS. 9A-FIG. 9C is a graph illustrating accumulation of fatigue scores of each aircraft body obtained when the operation management illustrated in FIG. 8A-FIG. 8C has been performed.

In this example, three aircraft bodies 1, 2, and 3 are operated in respective regions A, B, and C. The region A is a tropical region, the region B is a mild climate region, and the region C is a cold region, for example. Thus, the load exerted on the aircraft bodies descends in order of the regions A, B, and C.

As illustrated in FIGS. 8A-FIG. 8C, according to this operation management, during a period FIG. 8A, the aircraft body 1 is managed to operate in the region A, the aircraft body 2 is managed to operate in the region B, and the aircraft body 3 is managed to operate in the region C. During the following period FIG. 8B, the aircraft body 1 is managed to operate in the region B, the aircraft body 2 is managed to operate in the region C, and the aircraft body 3 is managed to operate in the region A. Furthermore, during the following period FIG. 8C, the aircraft body 1 is managed to operate in the region C, the aircraft body 2 is managed to operate in the region A, and the aircraft body 3 is managed to operate in the region B. Thereafter, such a swapping loop of the operation patterns is repeated.

FIGS. 9A-FIG. 9C illustrate accumulation of fatigue scores of each aircraft body obtained when the above operation management has been performed. The drawing in the left illustrates the fatigue score of each aircraft body that has accumulated in the period FIG. 9A. The drawing in the middle illustrates the fatigue score of each aircraft body that has accumulated in the period FIG. 9A and the period FIG. 9C. The drawing in the right illustrates the fatigue score of each aircraft body that has accumulated in the period FIG. 9A to the period FIG. 9C.

As illustrated in FIGS. 9A-FIG. 9C, by performing the operation management in which the operation patterns of the equipment are swapped in a loop, the fatigue level that accumulates in each aircraft body becomes even by the period FIG. 9C. Thus, the fatigue level is leveled among the aircraft bodies, and the maintenance timing can be concentrated at the same timing, for example.

In the example illustrated in FIGS. 8A-FIG. 8C and FIGS. 9A-FIG. 9C, the operated regions of these pieces of equipment are swapped in a loop to make the fatigue level of each aircraft body even, but the operation management is not limited to this example.

For example, in place of leveling the fatigue level of each aircraft body, the operation management may be performed such that the timing at which the fatigue score of each aircraft body reaches the reference fatigue score is adjusted. Specifically, the operation management may be performed such that the fatigue score of the aircraft body 1 reaches the reference fatigue score and then the fatigue scores of the aircraft body 2 and the aircraft body 3 reach the reference fatigue score at a prescribed interval. In this case, the aircraft body 1, the aircraft body 2, and the aircraft body 3 can be maintained at a prescribed interval, and the maintenance facilities can be used efficiently.

Alternatively, when the flight frequency (the number of flights per given period) differs in different regions, the maintenance timing of each aircraft body may be adjusted by changing the operated regions of the aircraft bodies in consideration of the flight frequency.

According to the present embodiment, the operation of the equipment can be managed appropriately based on the operation pattern of the equipment.

### Sixth Embodiment

A sixth embodiment provides an actuator (not illustrated) that includes a fatigue level calculating device. The fatigue level calculating device includes an environment information acquiring unit and a fatigue level calculating unit. The environment information acquiring unit acquires the environment information pertaining to the environment in the surroundings of the actuator. The fatigue level calculating unit calculates the relationship between the operation condition of the actuator and the fatigue level of the actuator based on the environment information acquired by the environment information acquiring unit.

### Seventh Embodiment

A seventh embodiment provides an actuator controlling device (not illustrated) that includes a fatigue level calculating device. The fatigue level calculating device includes an environment information acquiring unit and a fatigue level calculating unit. The environment information acquiring unit acquires the environment information pertaining to the environment in the surroundings of the actuator controlling device. The fatigue level calculating unit calculates the relationship between the operation condition of the actuator controlling device and the fatigue level of the actuator controlling device based on the environment information acquired by the environment information acquiring unit.

### Eighth Embodiment

An eighth embodiment provides an aircraft (not illustrated) that includes a fatigue level calculating device. The fatigue level calculating device includes an environment information acquiring unit and a fatigue level calculating unit. The environment information acquiring unit acquires the environment information pertaining to the environment in the surroundings of the aircraft. The fatigue level calculating unit calculates the relationship between the operation condition of the aircraft and the fatigue level of the aircraft based on the environment information acquired by the environment information acquiring unit.

Thus far, the description has been given based on the embodiments of the present invention. These embodiments, however, are merely illustrative, and it should be appreciated by a person skilled in the art that various modifications and changes can be made within the scope set forth by the claims of the present invention and that such modifications and changes also fall within the scope set forth by the claims of the present invention. Accordingly, the description and the drawings of the present specification are not to be construed as limiting but are to be construed as illustrative.

### VARIATIONS

Some variations will be described below. In the description of the variations, constituent elements and members that are identical or equivalent to those in the embodiments are given identical reference characters. Descriptions that are duplicate of those in the embodiments will be omitted as appropriate, and the following description focuses on configurations that differ from the configurations of the embodiments.

In the foregoing embodiments, the operation pattern is a physical outer environment, such as the temperature, the humidity, the amount of dust, the surge voltage, the concentration of a chemical substance, or the radiation exposure dose. The operation pattern, however, is not limited to the above.

### Variation 1

The operation pattern may be an operation duration of equipment. Even if the duration in which an aircraft is not in service is included, the passage of time since an aircraft body begins being operated results in a load that causes the fatigue of the aircraft body to progress due to deterioration over time. Therefore, when an aircraft body with a longer operation duration and an aircraft body with a shorter operation duration are compared, the former has a higher fatigue level even with the same number of flights.

An environment information acquiring unit of a fatigue level calculating device according to the present variation acquires information on the operation duration of an aircraft body in place of or in addition to the environment information described above. Then, the fatigue level calculating unit calculates the relationship between the operation condition of the equipment and the fatigue level of the equipment based on the information including the operation duration. Other configurations of the fatigue level calculating device according to the present variation are the same as those of the fatigue level calculating device according to the foregoing embodiments.

According to the present variation, the relationship between the operation condition of the equipment and the fatigue level of the equipment can be predicted with higher accuracy by reflecting the length of the operation duration on the calculation of the fatigue level.

### Variation 2

The operation pattern may be a flight distance of an aircraft body. A load exerted on an aircraft while the aircraft is flying horizontally with no landing or takeoff operation also results in a load that causes the fatigue of the aircraft body to progress. Therefore, when an aircraft body with a longer flight distance and an aircraft body with a shorter flight distance are compared, the former has a higher fatigue level even with the same number of flights.

An environment information acquiring unit of a fatigue level calculating device according to the present variation acquires information pertaining to the flight distance of an aircraft body in place of or in addition to the environment information described above. Then, the fatigue level calculating unit calculates the relationship between the operation condition of the equipment and the fatigue level of the equipment based on the information including the flight distance. Other configurations of the fatigue level calculating device according to the present variation are the same as those of the fatigue level calculating device according to the foregoing embodiments.

According to the present variation, the relationship between the operation condition of the equipment and the fatigue level of the equipment can be predicted with higher accuracy by reflecting the length of the flight distance on the calculation of the fatigue level.

### Variation 3

The operation pattern may be an “environment class” classified based on a combination of different pieces of environment information.

For example, a case in which the temperature and the humidity are used as the different pieces of environment information will be considered. In this case, based on the combination of the temperature and the humidity, the environment classes classified into the following four classes are defined.

Class A: high temperature and high humidity

Class B: low temperature and high humidity

Class C: high temperature and low humidity

Class D: low temperature and low humidity

The load exerted on the aircraft body in this case descends in order of the classes A, B, C, and D.

The relationship between the number of flights and the fatigue level of the aircraft body corresponding to each environment class can be calculated by analyzing the number of flights of the plurality of aircraft bodies operated in the classes A, B, C, and D and data on the frequency of failures.

An environment information acquiring unit of a fatigue level calculating device according to the present variation acquires information pertaining to the environment class in which an aircraft body has been operated in place of or in addition to the environment information described above. Then, a fatigue level calculating unit calculates the relationship between the operation condition of the equipment and the fatigue level of the equipment based on the information including the environment class. Other configurations of the fatigue level calculating device according to the present variation are the same as those of the fatigue level calculating device according to the foregoing embodiments.

As the different pieces of environment information, any suitable weather information, such as the highest temperature, the lowest temperature, the dew point, the wind speed, the amount of precipitation, or lightning, in addition to the temperature and the humidity described above may be used.

According to the present variation, the relationship between the operation condition of the equipment and the fatigue level of the equipment can be predicted with higher accuracy by taking into consideration the combination of different pieces of environment information as the operation pattern.

In the foregoing examples, various pieces of environment information indicating the operation pattern have been described. The environment information acquiring unit may acquire some or all of these pieces of environment information. Then, the fatigue level calculating unit may calculate the relationship between the operation condition of the equipment and the fatigue level of the equipment based on some of all of these pieces of environment information.

### Variation 4

A fatigue level calculating method according to the present variation includes an assessment step in addition to the steps in the fatigue level calculating method illustrated in FIG. 5.

In the assessment step, the method assesses the value of the equipment based on the fatigue level calculated from the relationship calculated in the fatigue level calculating step. The assessment may be made, for example, by automatically referring to a table indicating a relationship between the accumulated fatigue level and the price of the aircraft body or a component.

As described above, that the fatigue score is high means that the extend of fatigue or deterioration of the aircraft body or the component is large, that is, the number of flights left before a failure occurs is small. Conversely, that the fatigue score is low means that the extend of fatigue or deterioration of the aircraft body or the component is small, and the number of flights that can be made before a failure occurs is large. In other words, an aircraft body or a component with a high fatigue score can be evaluated as having a low value, and conversely an aircraft body or a component having a low fatigue score can be evaluated as having a high value. Accordingly, the resale price of the aircraft body or the component can be assessed based on the fatigue score.

In addition, an aircraft body equipped with a plurality of components may have its entire resale place assessed based on the total value of the fatigue scores of the respective components or the weighted total value.

When a certain component has been repaired or replaced, the fatigue score of that component decreases, and thus the total value of the fatigue scores of the aircraft body as a whole also decreases. Accordingly, in this case, an assessment may be made such that the resale place of the aircraft body as a whole increases.

According to the present variation, the value of the equipment can be assessed appropriately based on the fatigue level calculated from the relationship between the operation condition of the equipment and the fatigue level of the equipment.

Any optional combination of the embodiments and the variations described above is also effective as an embodiment of the present invention. A new embodiment conceived of through such a combination has combined effects of the embodiments and the variations combined.

What is claimed is:

1. A fatigue level calculating device, comprising:
an environment information acquiring unit that acquires environment information pertaining to an environment in surroundings of equipment; and
a fatigue level calculating unit that calculates a relationship between an operation condition of the equipment and a fatigue level of the equipment based on the environment information.

2. The fatigue level calculating device according to claim 1, wherein
the environment information acquiring unit acquires the environment information during operation of the equipment.

3. The fatigue level calculating device according to claim 1, wherein
the environment information acquiring unit acquires the environment information before operation of the equipment.

4. The fatigue level calculating device according to claim 1, wherein
the environment information acquiring unit acquires the environment information after operation of the equipment.

5. The fatigue level calculating device according to claim 1, wherein
the environment information includes at least one of a temperature, a humidity, an amount of dust, a surge voltage, a concentration of a chemical substance, and a radiation exposure dose.

6. The fatigue level calculating device according to claim 1, wherein
the environment information acquiring unit includes a sensor provided in the surroundings of the equipment.

7. The fatigue level calculating device according to claim 1, wherein
the environment information acquiring unit acquires the environment information based on weather information.

8. The fatigue level calculating device according to claim 1, wherein
the fatigue level calculating unit calculates the relationship between the operation condition of the equipment and the fatigue level of the equipment through fitting onto a predetermined function or machine learning.

9. The fatigue level calculating device according to claim 1, wherein
the equipment is transportation equipment or a device constituting a portion of the transportation equipment.

10. A fatigue level calculating method, comprising:
an environment information acquiring step of acquiring environment information pertaining to an environment in surroundings of equipment; and
a fatigue level calculating step of calculating a relationship between an operation condition of the equipment and a fatigue level of the equipment based on the environment information.

11. The fatigue level calculating method according to claim 10, wherein
the fatigue level calculating step includes calculating the relationship between the operation condition of the equipment and the fatigue level of the equipment through fitting onto a predetermined function or machine learning.

12. The fatigue level calculating method according to claim 10, further comprising:
an evaluating step of comparing the fatigue level calculated from the relationship calculated in the fatigue level calculating step against a predetermined threshold for an evaluation.

13. The fatigue level calculating method according to claim 10, further comprising:
a managing step of managing an operation of the equipment based on the fatigue level calculated from the relationship calculated in the fatigue level calculating step.

14. The fatigue level calculating method according to claim 10, wherein
the equipment is transportation equipment or a device constituting a portion of the transportation equipment.

15. An actuator, comprising:
an output unit that outputs a power;
an environment information acquiring unit that acquires environment information pertaining to an environment in surroundings of the output unit; and
a fatigue level calculating unit that calculates a relationship between an operation condition of the output unit and a fatigue level of the output unit based on the environment information acquired by the environment information acquiring unit.
